(19) United States
(12) Patent Application Publication
(10) Pub. No.: US 2003/0093304 A1
(43) Pub. Date: May 15, 2003

(54) System and method for managing short term risk

(76) Inventors: James B. Keller, Fort Wayne, IN (US); Karen J. Edgerton, Fort Wayne, IN (US)

Correspondence Address: Barnes & Thornburg, 600 One Summit Square, Fort Wayne, IN, 46802, US

(21) Appl. No.: 10/281,756

(22) Filed: Oct. 28, 2002

Related U.S. Application Data
(60) Provisional application No. 60/335,299, filed on Nov. 2, 2001.

(51) Int. Cl. G06F 17/60

(52) U.S. Cl. 705/4; 705/38

(57) ABSTRACT

A method for evaluating and managing short term risk includes the steps of identifying a population of risks, assigning baseline factors to risks in the population, developing, by a statistical regression technique, a table of modification factors, modifying the baseline factors assigned to the risk and generating one or more quotes for insurance coverage using the modified factors. A system with which the method may be practiced includes first and second computers, and programs to allow a user of the second computer to generate one or more quotes on the first computer for review and consideration. The system and method allow for more precise and rigorous analysis and underwriting of certain short term risks.

### RELATED APPLICATIONS

The present application is related to and claims priority to U.S. Provisional Patent Application Serial No. 60/335,299, filed on Nov. 2, 2001, entitled System and Method for Managing Short Term Risk. The subject matter disclosed in that provisional application is hereby expressly incorporated into the present application.

### FIELD OF INVENTION

This invention relates generally to risk management and, more specifically, to a method and system for managing certain types of risks known in the insurance industry as “short term” risks.

### BACKGROUND AND SUMMARY OF THE INVENTION

Insurance companies are in the business of managing (and helping their clients manage) insurable risks. Within the industry, insurable risks may be classified as one of two types—long term risks and short term risks. Long term risks are those which are underwritten prior to the beginning of a coverage which may extend for many years, and in some cases until the occurrence of the insurable event. When insuring long term risks, an insurance company has but one opportunity to underwrite or evaluate the risk. Examples of long term risks include individual life insurance, individual long term care insurance, individual disability insurance and individual medical insurance.

Short term risks are those that are underwritten or evaluated on a recurring periodic basis. Many of these risks are underwritten annually, biannually, or after some other relatively brief time period. When insuring short term risks, insurance companies have periodic opportunities to reevaluate the risk and to reflect changes in conditions which may impact the risk in the design and pricing of insurance products. Examples of short term risks include group life insurance, group medical insurance, short term and long term disability insurance for groups, workers compensation insurance, and many property/casualty insurance coverages, such as auto insurance, home insurance, directors and officers liability insurance, medical and legal malpractice insurance, and other types of coverage which expire or renew periodically.

U.S. Pat. No. 4,975,840 discloses a method and apparatus for evaluating a potentially insurable risk. The method and apparatus disclosed and claimed in U.S. Pat. No. 4,975,840 may be used in evaluating all types of risks, including both long and short term risks. The particular embodiment described to illustrate the invention of the '840 patent is a long term risk (individual life insurance), although the method and apparatus described there may be used to evaluate other types of risks.

The invention of the present application is more particularly directed to the evaluation of short term risks. Specifically, the invention of the present application provides a system and method to facilitate initial evaluation, and periodic reevaluation (i.e., re-underwriting), of various types of short term risks.

As in the '840 patent, the present invention will be described by reference to a particular type of short term risk (group life insurance). However, reference to this particular application is intended to be illustrative only, and is not intended to limit the scope of the invention. The method and system of the present invention may be used to facilitate the design and pricing of insurance products covering various types of risks which are reevaluated periodically.

As noted, the present invention is described below by reference to group life insurance. Historically, group life insurance has been viewed as a relatively uncomplicated adjunct to group medical or group disability insurance coverage. Actuaries and underwriters of insurers offering these products tended to focus their attention on the medical or disability insurance product, which typically represents higher risk for their companies. Customers paid close attention to the larger health insurance premiums, with limited review of group life insurance costs. In this environment, group life insurance premiums could be set to yield comfortable returns, and efforts to develop a more sophisticated understanding of expected mortality costs were viewed as unnecessary. In any event, rates could be raised or lowered as needed in the next renewal period.

In recent years, the group life insurance market has changed significantly, becoming more competitive with increased emphasis on rates and features. The steady returns upon which group life insurers relied have become less certain. Many factors have contributed to this shift, including:

1. poor results in the group medical segment have increased interest in group life as a profit and growth source;

2. many companies have stopped writing medical business and increased their focus on group life;

3. customers are increasingly unbundling buying decisions, looking at group life apart from medical coverage;

4. insurers face pressure for higher guarantee issue limits and longer rate guarantees;

5. credibility factors in many cases are significantly more aggressive than justified by statistical theory; and

6. standard industry mortality tables are dated, and good recent industry mortality data is lacking.

These changing market conditions create a need for new tools and approaches to the underwriting of this particular type of short term risk. In many respects, the present invention is a response to these changing market conditions.

One aspect of the system and method of the present invention is the provision of an input data template to facilitate collection of input data used in the process of evaluating short term risk. Another aspect of the system and method is the provision of a computer program which includes data, information and routines which, when combined with input data from the input template, facilitates generation of quotes for insurance coverage of the subject risk. In one embodiment, the input data template, in the form of a spreadsheet, is downloaded or otherwise provided to a user's computer system. The template is populated with data regarding the subject risk. The data are communicated from the user's computer system to an insurance provider's computer system. That system accesses the data in the input template and uses the data to generate one or more quotes for insurance coverage. The quote is made available to the user's computer system for display to the user. Quotes may be accepted, stored, archived, and otherwise administered in a manner which facilitates the provision of multiple quotes for multiple scenarios of coverage and for multiple risks, and at periodic intervals.

Certain embodiments of the present invention relate to a method of evaluating short term risk, which comprises the steps of identifying a population of individual risks, assigning a baseline factor to each of the individual risks in the population, developing, by a statistical regression technique, a table of modification factors, modifying the baseline factors, using one or more of the modification factors, assigned to the individual risks, and generating a quote for insurance coverage for the short term risk using the modified baseline factors. The step of developing, by a statistical regression technique, the table of modification factors may include one or more of the steps of determining the relative importance of a plurality of factors correlated to the short term risk, determining the relative degree of correlation of a plurality of factors correlated to the short term risk, and selecting a plurality of factors correlated to the short term risk. In certain embodiments, the plurality of factors may include two or more of the following: benefit class schedule, age, gender, amount of coverage, waiver of premium definition, dependent spouse and child coverages, cases with premium continuance for disabled lives, supplemental coverages, smoking status, relevant recent experience, industry, income, location of workplace, marital status, education, and occupation.

In certain embodiments of the invention, the step of generating a quote includes the step of generating a plurality of alternative quotes for review and consideration by a user. These embodiments may include the additional steps of generating indicia and assigning the indicia to the quotes.

Some embodiments of the invention may include the step of collecting data relating to the individual risks. In these embodiments, the step of collecting data may include the step of populating a data template with data relating to the individual risks. The step of generating a quote may comprise the step of calculating, using the data from the data template, insurance rates and one or more rates for additional coverages or features. In a particular embodiment, the short term risk is a group life insurance product and the data template includes data fields for entry of data concerning individual members of a covered population. The data fields may include data relating to one or more of the plurality of factors correlated to the short term risk listed above. In this or an alternative embodiment, the data template may include data fields relating to at least one of classes of coverage, a sponsoring entity providing a life insurance benefit to a covered population, and limits and features of the group life insurance product.

Certain embodiments of the method may further comprise the step of reviewing a quote to determine a need for facultative review and, if needed, the steps of obtaining review by an insurer or re-insurer, entering information received as a result of the review, and regenerating the subject quote. Embodiments of the invention may also include the additional step of saving quotes in a quote file, and the additional steps of conducting experience analysis on quotes saved in the quote file and producing a management report.

One embodiment of the invention comprises the additional steps of providing a computer having a memory, and storing data relative to the individual risks, the baseline factors and the modification factors in the computer memory for use in the step of generating a quote. At least one embodiment includes the additional steps of providing a first computer, establishing communications between the first computer and a second computer, transferring a data template from the first computer to the second computer, and using the second computer, populating the data template with data relating to the short term risk. One embodiment of the invention which utilizes a first and second computer further comprises the step of providing a user of the second computer with a menu of options from which to select an operation to be performed on the first computer. The options include one or more of the following: download an input template; generate a quote for insurance coverage for short term risk; view past quotes generated by and stored on the first computer; view sold quotes stored in the first computer; and view a user agreement. This method further includes the steps of monitoring for a selection made by the user, and implementing the selected operation. This and/or other embodiments in which the short term risk is a group life insurance product for a population of individuals may further comprise the additional steps of constructing a table of baseline factors and storing the table in the first computer. The table of baseline factors may be broken down by gender and age. This method further comprises the additional step of storing a table of modification factors in the first computer. The modification factors are statistically related to at least one of the plurality of factors previously referenced. Additional factors (for example, an anti-selection factor and a risk factor) may also be considered.

Other embodiments of the present invention relate to a system for evaluating short term risk. In one embodiment, such a system comprises a first computer, means for establishing communications between the first computer and a second computer (e.g., a network), a program for providing a user of the second computer with a menu of options from which to select an operation to be performed on the first computer, means for monitoring for a selection made by the user, and means for implementing the selected operation. The options available to a user of the second computer may include one or more of the following:

1. download an input template;

2. generate a quote for insurance coverage for a short term risk;

3. view past quotes generated by and stored on the first computer; and

4. view sold quotes stored in the first computer.

In one embodiment, the first computer has a memory element for storing data relating to the short term risk. The data may be entered in the input template by a user of the second computer system, and subsequently communicated to the first computer system for storage in the memory element. A table of baseline factors relating to the short term risk, and a table of modification factors, may also be stored in the memory element. A computer program is provided for generating a quote for insurance coverage for the short term risk using the data, one or more of the baseline factors, and one or more of the modification factors stored in the memory element. Certain embodiments of the system may further include a monitor or other output device for displaying a generated quote to a user of the second computer system.

In certain embodiments of the system, the modification factors are statistically related to at least one of income, education, occupation, and marital status. In these embodiments, the short term risk is a group life insurance product. Such embodiments may further comprise means for identifying a population of individuals to be covered by the product, means for assigning a baseline factor to each of the individuals in the population, and means for modifying the baseline factors, using one or more of the modification factors stored in the memory element. Such means may include a computer program, or programs, stored in the memory element. Programs may also be included for generating a quote for insurance coverage for the product using the modified baseline factors. In certain embodiments, a plurality of alternative quotes may be generated and stored in the memory element for review and consideration by a user. Identifying indicia may also be generated and assigned to the plurality of alternative quotes.

In certain embodiments of the system, the table of baseline factors is broken down by gender and age. In embodiments wherein the short term risk is a group life insurance product, data is collected relating to the risk. Such data may include one or more of the following: benefit class schedule, age, gender, amount of coverage, waiver of premium definition, dependent spouse and child coverages, cases with premium continuance for disabled lives, supplemental coverages, smoking status, relevant recent experience, industry, income, location of workplace, marital status, education, and occupation.

Other aspects of certain embodiments of the invention include the ability of the system and method to manage quotes that were previously created and/or sold to or by a system user. The system and method facilitate the incorporation of new risk factors in the actuarial and underwriting processes. New studies or information relevant to existing risk factors may be more easily incorporated into these processes, using the subject system and method.

In the context of the particular application described for purposes of illustrating the system and method of the present invention (i.e., group life insurance), one aspect of the invention includes a more precise and rigorous underwriting approach than has been previously applied. This aspect includes providing a particular embodiment of the system and method of the invention with a plurality of tables containing risk factors which are dependent upon a plurality of variables (income, occupation, marital status and education) which have not previously been used in underwriting group life insurance risks. Mortality data for the subject variables developed by statistical correlation and actuarial analyses are combined in multidimensional tables to produce factors which are used to modify or adjust baseline factors to provide more exact and precise underwriting for particular populations. The added rigor and statistical analyses may be advantageously used to justify and support rate structures for insurance products. This capability may be additionally useful in the future if the regulatory environment continues to evolve to further favor or require such justification and support.

Other aspects, advantages and novel features of the system and method of the present invention will become apparent from the following description of the invention when considered in conjunction with the accompanying drawings.

### BRIEF DESCRIPTION OF THE DRAWINGS

FIG. 1 shows a flow chart which illustrates the overall workings of an illustrative embodiment of the system and method of the present invention.

FIG. 2 shows a flow chart which illustrates the login process of the system of FIG. 1 in additional detail.

FIG. 3 shows a flow chart which illustrates a portion of the embodiment of FIG. 1 relating to acceptance of a user agreement.

FIG. 4 shows a flow chart which illustrates main menu options of the embodiment of FIG. 1.

FIG. 5 shows a flow chart which illustrates the main page option of FIG. 4.

FIG. 6 shows a flow chart which illustrates the download input template option of FIG. 4.

FIG. 7 shows a flow chart which illustrates the generate quote option of FIG. 4.

FIG. 8 shows a flow chart which is a continuation of the flow chart of FIG. 7.

FIG. 9 shows a flow chart which is a continuation of the flow chart of FIG. 8.

FIG. 10 shows a flow chart which is a continuation of the flow chart of FIG. 9.

FIG. 11 shows a flow chart which illustrates the view past quotes option of FIG. 4.

FIG. 12 shows a flow chart which illustrates the view sold quotes option of FIG. 4.

FIG. 13 shows a flow chart which illustrates the view user agreement option of FIG. 4.

FIG. 14 shows a flow chart which illustrates generation of an error message.

FIG. 15 shows a flow chart which illustrates generation of an error message.

FIGS. 16 and 17 illustrate one form of a system input template for use in collecting census and other data for use by the system and method of FIG. 1.

FIG. 18 illustrates a portion of a standard mortality table of the type used to establish a baseline rate in the system and method of FIG. 1.

FIGS. 19 illustrates a portion of a table of factors which reflect the impacts of income, education, occupation and marital status on group life mortality.

FIG. 20 illustrates a portion of a table of factors used to establish a baseline rate for accidental death and dismemberment coverage.

FIG. 21 shows an illustrative sample output of the system and method of FIG. 1.

FIG. 22 shows another illustrative sample output of the system and method of FIG. 1.

### DETAILED DESCRIPTION OF THE DRAWINGS

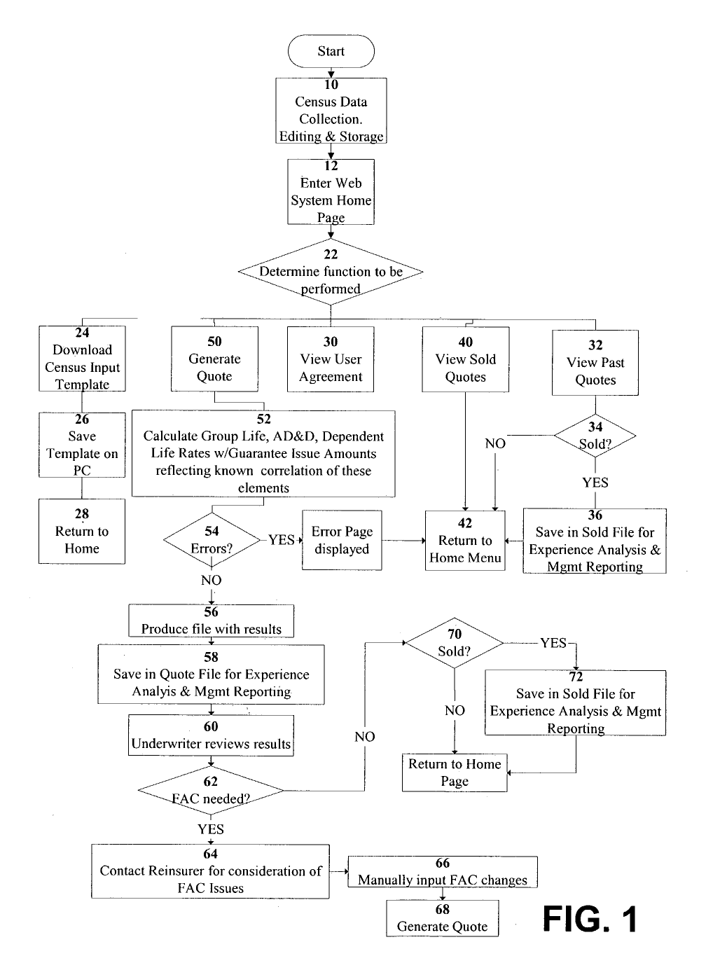

FIG. 1 shows a flow chart which illustrates the overall workings of an illustrative embodiment of the system and method of the present invention. The first step in the method and system illustrated by FIG. 1 is the step of collecting, editing, and storing census data (10). This operation is preferably performed by the user “offline” with the aid of a template (e.g., a spreadsheet) discussed in additional detail below. If the census data and other information for the subject population has previously been entered into an appropriate template, this step may be omitted.

After all applicable input data has been loaded in the template for a particular population or application, the user proceeds to enter the system (12). The particular embodiment illustrated is intended to be implemented in a web environment using readily available web browser and programming technology. The system may be implemented using the Internet, an Intranet, or other network environment. However, the scope of the invention is not limited to applications which use existing networking technology.

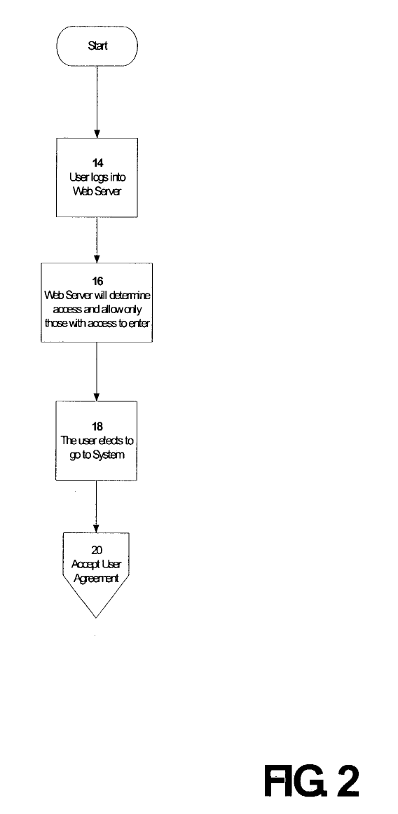

Additional steps associated with entering the embodiment illustrated in FIG. 1 are illustrated in the flow charts of FIGS. 2, 3 and 4. With reference to FIG. 2, a user logs into an external web server (14). The system will determine if the user attempting to log in has access rights to the system and allow only those with such access rights to complete the log in process (16). If the system is unable to identify the user, an error screen is generated and access is denied. If the system identifies and accepts the user, and the user elects to enter the system (18), the system requests that the user accept the system user agreement (20).

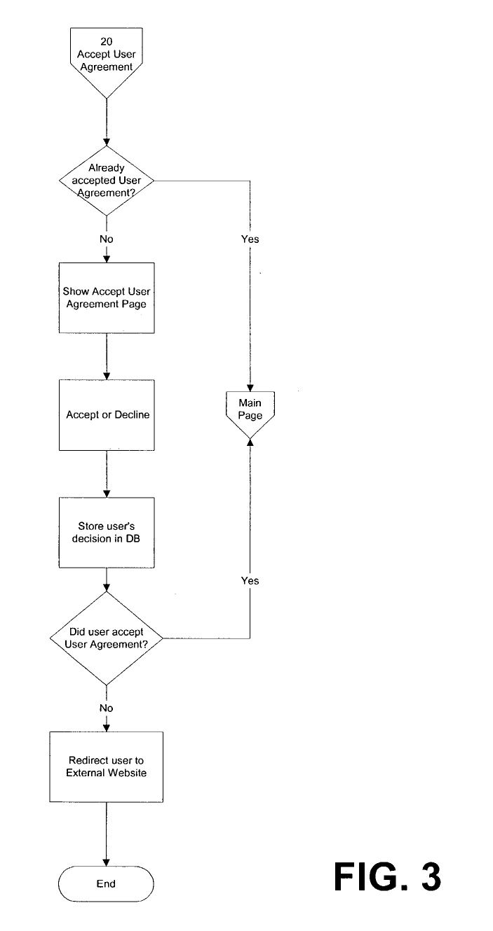

The process of acceptance of the user agreement is illustrated in detail in the flow chart of FIG. 3. After the agreement is accepted, the user is directed to a main or home page, as indicated in FIG. 3.

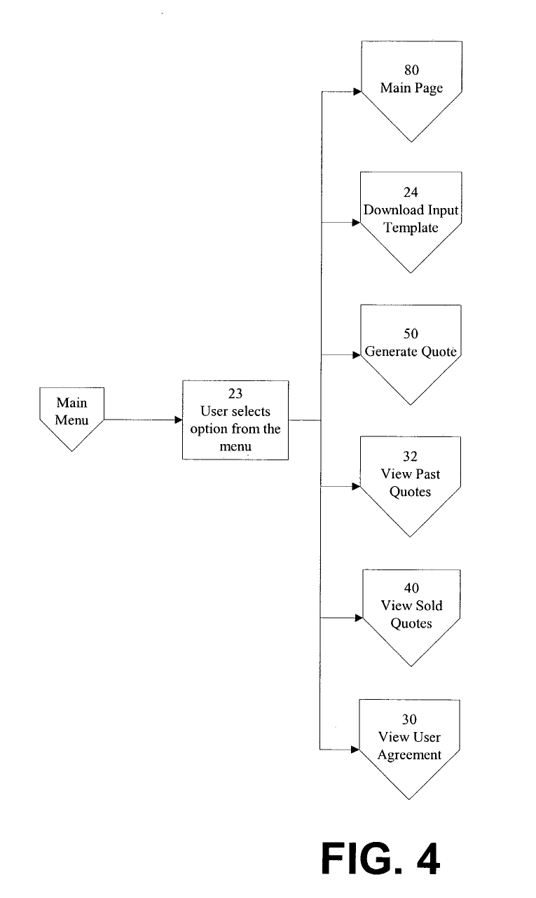

As illustrated in the flow chart of FIG. 4, the user is provided a main menu at the main or home page from which to select an option. In the embodiment illustrated, options include:

1) download the input template;

2) generate quote;

3) view past quotes;

4) view sold quotes; and

5) view user agreement.

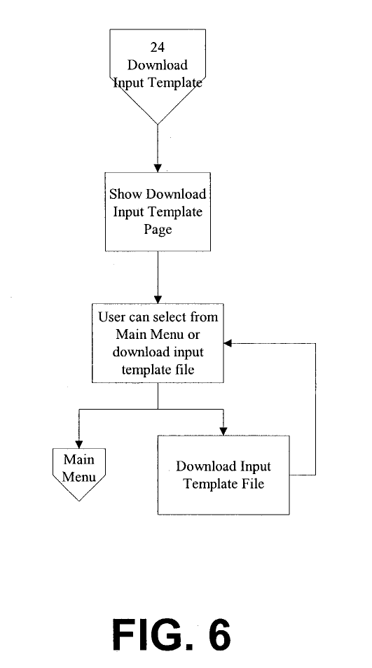

With reference to FIG. 4, the user selects the function or operation to be performed from the main menu. This operation is represented by block 22 in FIG. 1 and block 23 in FIG. 4. If the user has not downloaded an input template, that operation may be selected from the main menu. That operation is represented by block 24 shown in both FIGS. 1 and 4. The download process is illustrated in additional detail in the flow chart of FIG. 6. The actual downloading of the template file is accomplished, in the embodiment illustrated, by the user's web browsing software. The template is saved in the memory of the user's computer (26), and the user is returned to the main page at the end of the download process (28).

A second option available to the user from the home page is to view the user agreement (30). A third option is to view past quotes generated by the system (32). The system provides the user with the option of changing the status of past quotes from “unsold” to “sold” (34). If the quote is sold, it is saved in the “sold” file for experience analysis and management reporting purposes (36). After this operation, or in the event the quote has not been sold, the user is returned to the home page (38). A viewer may also view sold quotes (40) prior to electing to return to the home page (42).

The remaining option available to a user of the method and system illustrated by the flow chart of FIG. 1 is to generate a quote (50). This process involves calculating, using the information inputted into the census input template previously downloaded, group life rates, and rates for additional coverages and features, such as accidental death and dismemberment (AD&D) coverage, dependent life coverage, and guaranteed issue amounts. These calculations are represented generally in FIG. 1 by block 52. The calculations reflect what is known about the relationship between mortality and the particular factors in the census data collection, as well as the correlation of certain of these data elements. Following calculation, the system checks for errors (54) and, if none are found, produces a file with the results of the calculations (56). The subject file is saved in the quote file for experience analysis and management reporting purposes (58). The user may then review the results (60). In certain instances the user will indicate that facultative input is needed on certain issues (62). If so, the appropriate insurer or reinsurer is contacted for consideration of these issues (64). Information resulting from such contacts may be inputted manually and factored into a regeneration of the quote (66 and 68). If facultative issues are not considered, the system provides the user with the option of changing the status from “unsold” to “sold.” If the quote is sold, the file is saved with other sold files for experience analysis and management reporting purposes (72).

FIGS. 2-15 are additional flow charts which illustrate portions of the overall method and system of FIG. 1 in additional detail. Specifically, FIG. 2 (which is described in detail above) further illustrates the log in process through the point at which the user is asked to accept the user agreement. FIG. 3 further illustrates the process of acceptance of the user agreement. FIG. 4 schematically illustrates the options available to the user at the main or home page. Those options include: main page (80), download input template (24), generate quote (50), view past quotes (32), view sold quotes (40), and view user agreement (30). For purposes of consistency and clarity, blocks representing the same operation in more than one of the figures have been identified by the same reference numbers in the various figures.

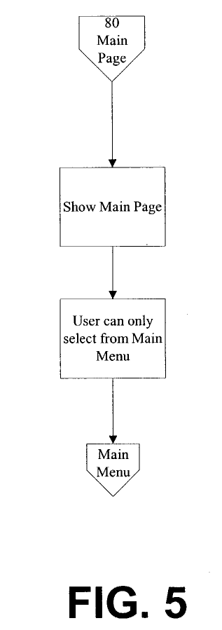

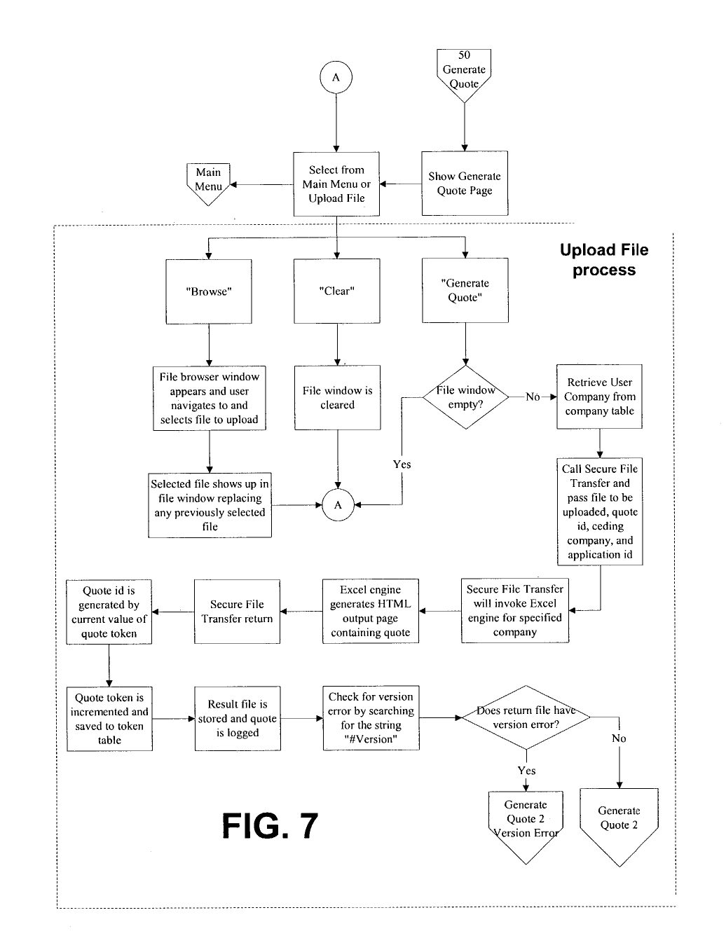

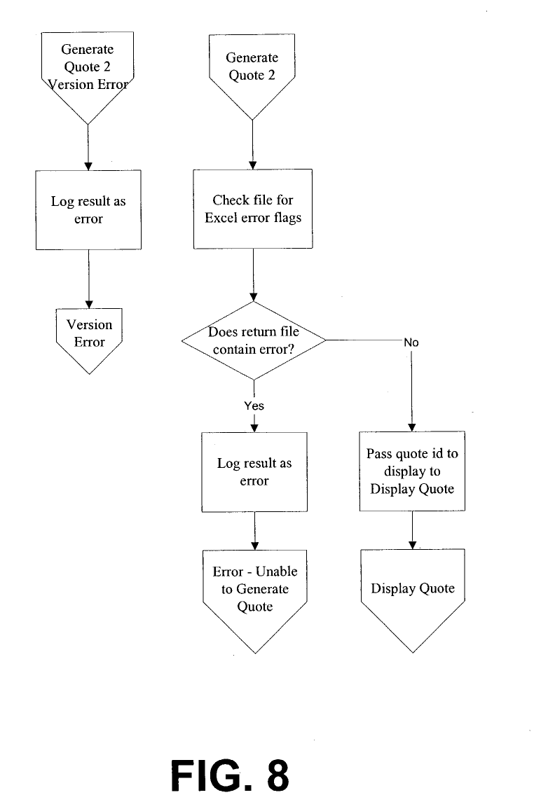

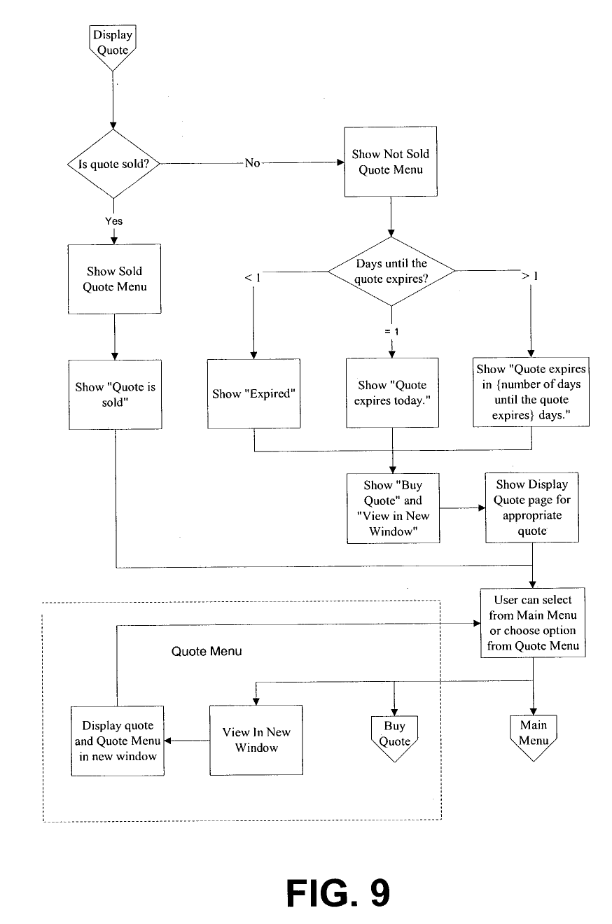

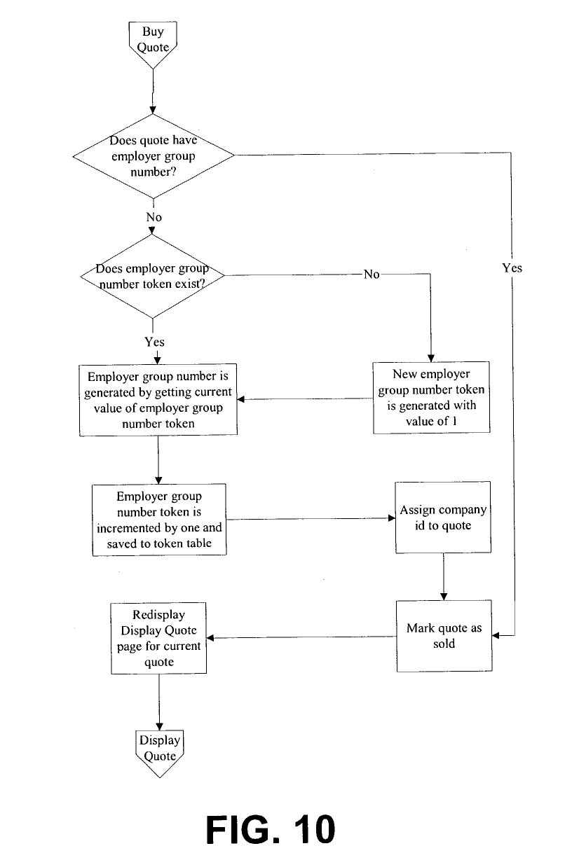

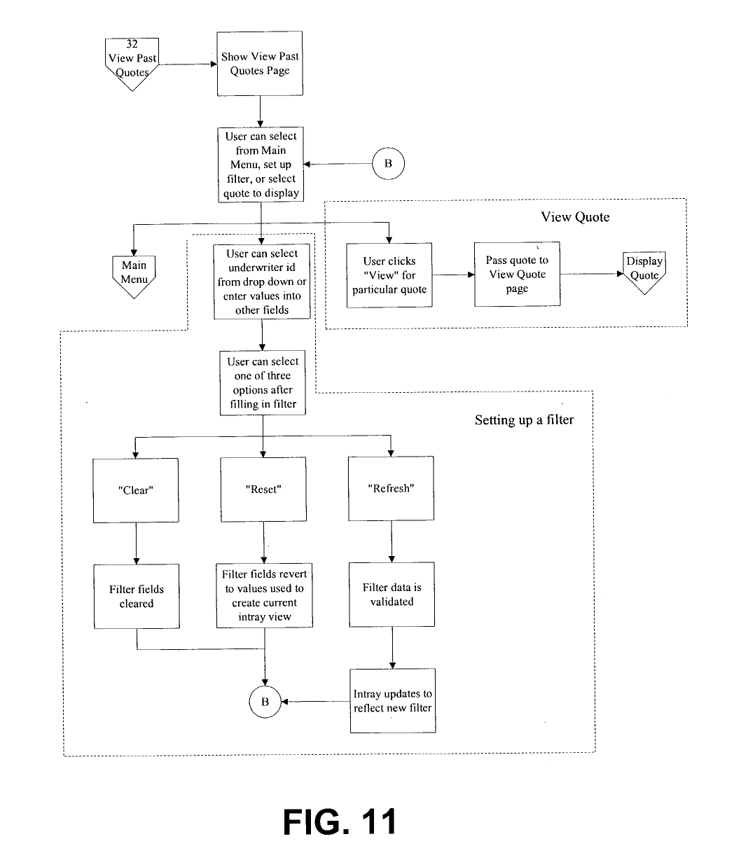

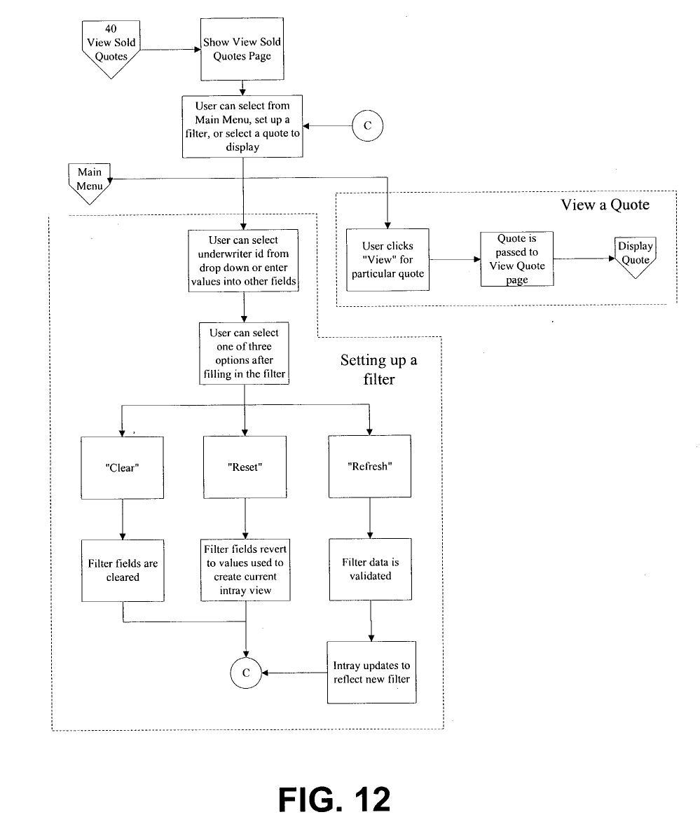

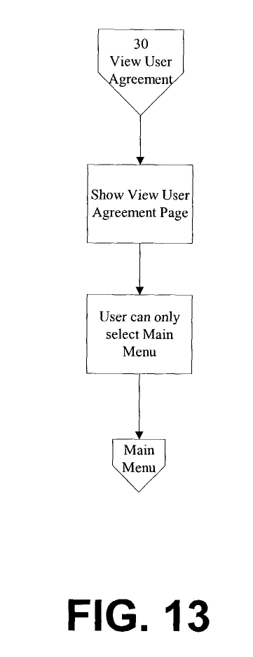

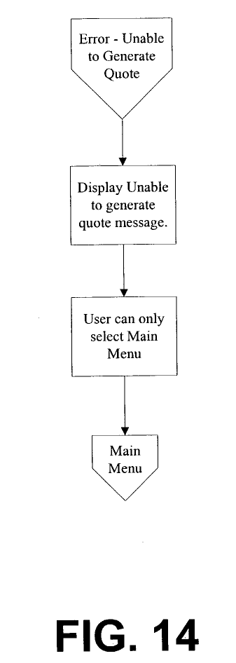

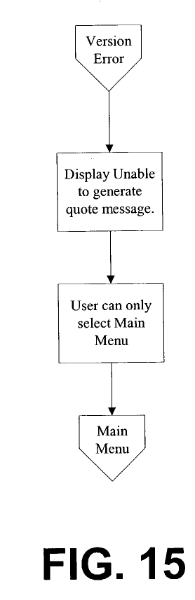

FIG. 5 further illustrates operation of the system and method when the user selects “Main Page” from the main menu. FIG. 6 further illustrates the process of downloading the input template to the user's computer. In one embodiment, the download process is handled by the web browser on the user's computer. FIGS. 7 and 8 further illustrate the process performed by the system when the user selects “Generate Quote” from the main menu. Although this flow chart is shown in substantial detail, it is to be understood that the subject invention is not limited to this particular embodiment. FIG. 9 is a continuation of FIG. 8 and shows details relating to the selection “Display Quote.” FIG. 10 is a continuation of FIG. 9 and further illustrates the process in connection with the “Buy Quote” option. FIG. 11 further illustrates the process performed by the system when the user selects the “View Past Quotes” option. FIG. 12 further illustrates the process performed by the system when the user selects the “View Sold Quotes” option. FIG. 13 further illustrates the process performed by the system when the user selects the “View User Agreement” option. FIGS. 14 and 15 illustrate the generation of error messages by the system.

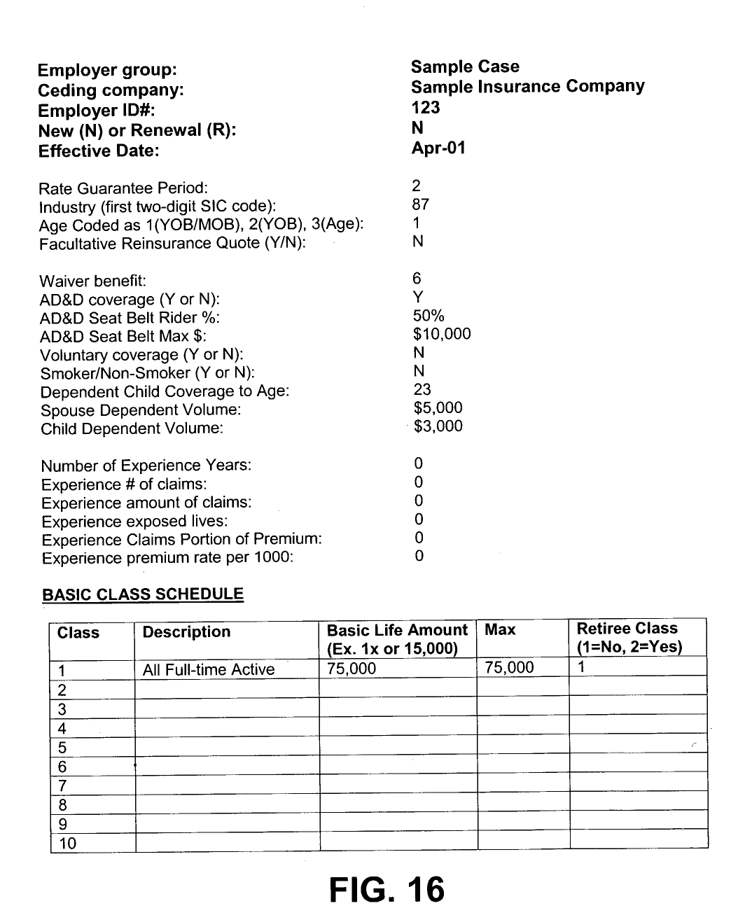

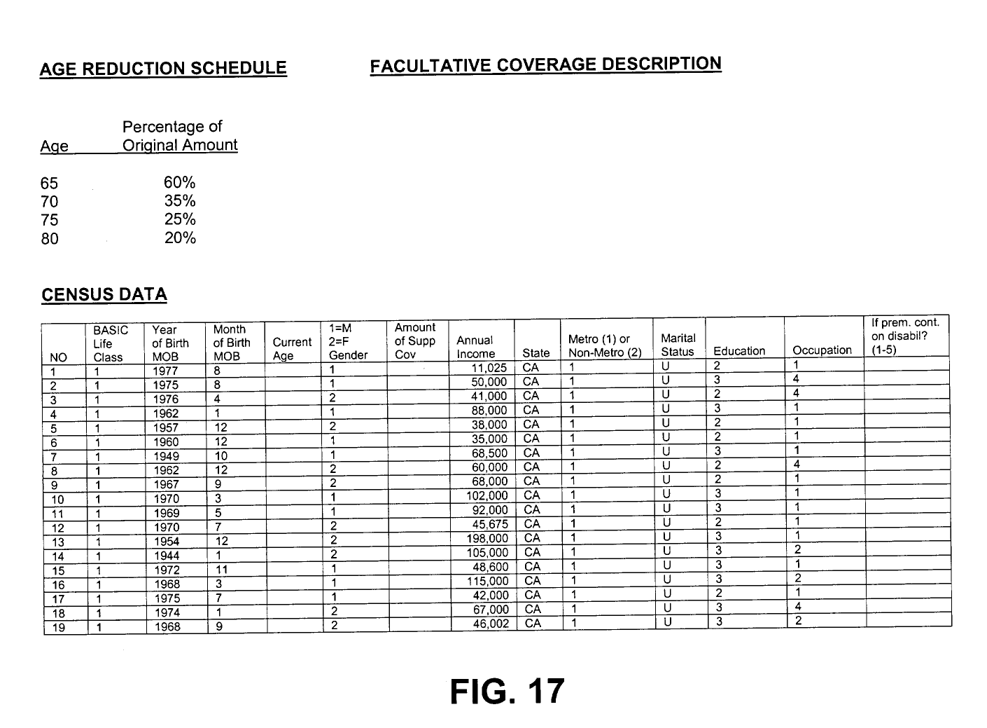

FIGS. 16 and 17 show one embodiment of an input template that is downloaded by the system user and used to collect information and census data concerning the particular risk, coverage, and population of interest. The template is designed to collect the data needed by the system to fully evaluate the risk in a particular format that the system recognizes and expects.

With specific reference to FIG. 16, sample data relating to an employer-provided group life insurance benefit is shown. The top entries identify the employer group, the ceding or insuring company, an employer I.D. number, an indication as to whether the coverage is new coverage or a renewal of existing coverage, and an effective date. Below this information is a vertical listing of fields (19 fields in the illustrative example of FIG. 16) in which information can be entered regarding specifics of the proposed coverage. Additional fields may be added, or fields may be deleted, as appropriate.

Included in the fields shown in FIG. 16 are several relating to claims experience with the particular group in question. In the absence of credible experience, the beginning points for underwriting group life insurance are mortality tables. These tables are readily available from a number of sources as is described more fully below. However, when credible experience is available with a particular group (e.g., from preceding terms in the case of renewals, or from prior coverages with other providers), such experience may be used in lieu of or in addition to the mortality tables. The system and method of the present invention thus allows for inputting information regarding such experience.

In the bottom portion of FIG. 16, data is entered in a table titled “Basic Class Schedule.” In the example illustrated, one class “All Full-time Active” is identified. In this example, up to ten classes of participants could be identified. Examples of additional classes include “Salaried,” “Hourly,” “Retirees,” etc. This information is useful in instances where different amounts of coverage are offered to different classes of participants.

The sample input template continues in FIG. 17. This portion of the template includes three tables. The first is titled “Age Reduction Schedule.” This table is provided in instances where coverage for certain participants decreases as participants age. A second table is titled “Facultative Coverage Description.” This table is populated with data in instances where conditions are set or permission is required from an insurer or reinsurer having an interest in the offered coverage.

The remaining table illustrated in FIG. 17 is titled “Census Data” and is intended to facilitate the collection and inputting of census data for the covered population. The example shown illustrates information entered for 19 individuals. Actual templates used with the method and system can provide for entry of census data for thousands of participants. Much of the information requested in this portion of the template is straight forward and needs no further explanation. Some of the information is entered by way of codes. For example, marital status may be indicated by “U” (unknown), “M” (married), or “S” (single, divorced, widowed, separated, etc.). Education may similarly be coded to indicate various levels of formal education. Occupations are similarly coded. One illustrative source of codes for occupations exists in the 1970 Bureau of the Census Index of Industries and Occupations. The last column in the Census Data table of FIG. 17 is provided to identify individuals having certain known conditions which may impact mortality (cancer, diabetes, heart disease, etc.). Conditions may be coded in accordance with known or custom methodologies.

In addition to the information illustrated in FIGS. 16 and 17, additional information may be collected in particular instances. For example, in situations where a significant number of participants work and/or reside in different countries, a column may be provided in the Census Data table to collect this information.

After the input template has been populated with the information and data applicable in a particular instance, the user is ready to use the “Generate Quote” function of the system. In the embodiments illustrated by the flow charts of FIGS. 1-15, the user logs onto the system and accesses the main menu. From the main menu, the user selects “Generate Quote” from the options available. In accordance with the flow chart of FIG. 7, the system uploads the census data and other information in the input template for use in producing a quote for the subject coverage.

The manner in which the system generates a quote for the requested coverage may differ based upon the type of risk, preferences of the user and the particular type of coverage offered. In the illustrative case of group life insurance discussed herein, companies have historically adopted relatively common practices in pricing such coverage. Standard mortality tables and group life experience studies are widely available and are used to generate a table of rates broken down by age, sex (gender), industry, and sometimes geographic area. Such tables may be updated based upon experience for a particular population in successive renewal periods. Other adjustments may be made reflecting employer/employee contributions, retiree plans, participation in supplemental or voluntary plans, or other factors. Underwriting and experience adjustments are sometimes heavily influenced by market conditions (i.e., the need to remain competitive with other providers). It is not uncommon for companies to provide discounts, particularly in the beginning of a relationship with a new population group.

One aspect of the present invention which relates to use of the method and system in a group life insurance setting involves the creation of multiple tables or databases in the system which contain factors relating to mortality. Baseline information on mortality is developed by accessing and analyzing available public and industry sources. One source of such information is the Berkeley Mortality Database (http://demog.berkeley.edu/wilmoth/mortality/). This database contains life tables for populations of the United States and certain other countries. Where available, the raw data used in constructing these tables is also available.

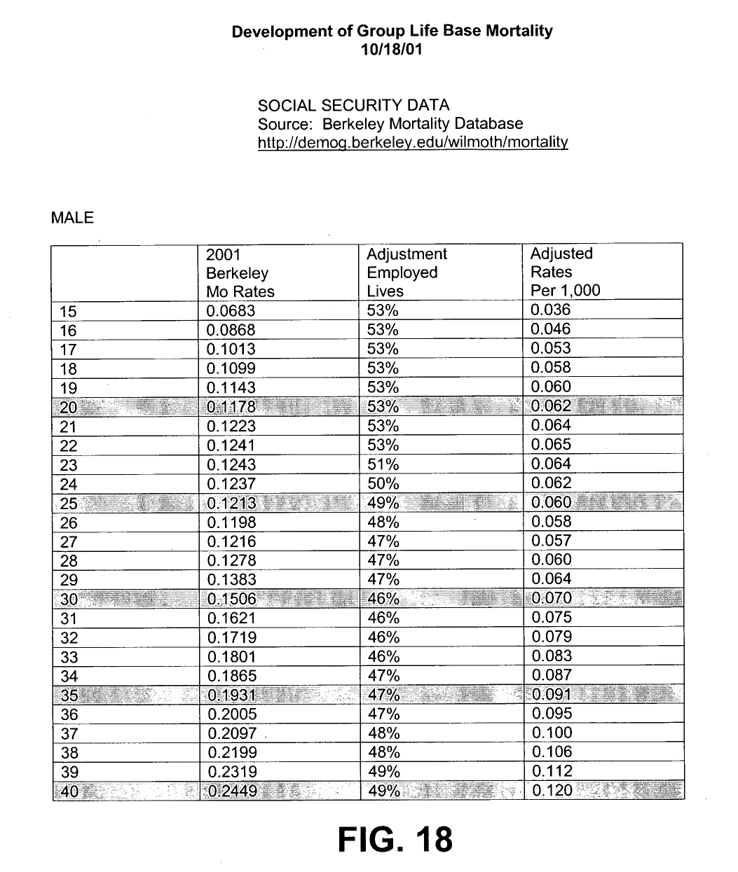

There are other sources of information publicly available that may be equally useful in establishing a baseline mortality factor for use in generating a quote for insurance coverage in accordance with the method and system of the present invention. These include the Society of Actuaries Experience Studies (www.soa.org), the U.S. Census Bureau, the U.S. Department of Health and Human Services-Social Security Administration, The U.S. Department of Labor, and others. In one embodiment of the present invention, tables of baseline rates broken down by sex (gender) and age are constructed and stored within the system. An illustrative portion of one such table is illustrated in FIG. 18. Such tables are used by the system to assign a baseline factor (which will be adjusted by other factors described below) to each individual in the subject population based on the census data collected in the input template.

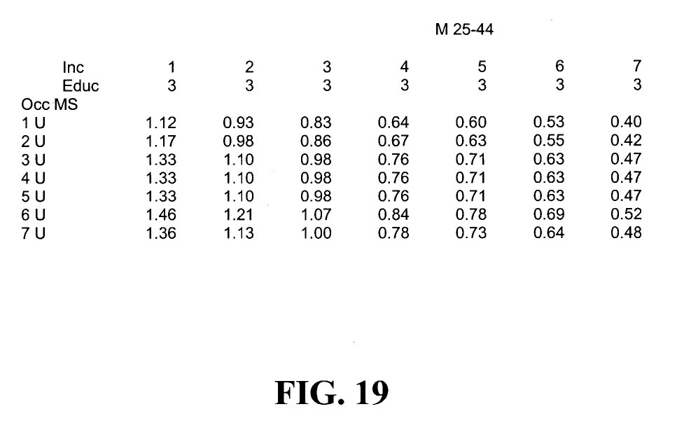

In one embodiment of the present invention, additional tables are developed and stored in the system for use in assigning a factor to each individual in the subject population, which factor is used to modify the baseline factor previously discussed. An example of such a table is shown in FIG. 19. This figure shows illustrative portions of a table of factors for males ages 25-44. The factors vary by income and education on the horizontal axis, and occupation and marital status on the vertical axis. Mortality data necessary to establish such factors, using standard statistical techniques, for groups within a selected population are publicly available. The factors contained in the tables are used to modify the baseline mortality factor for the individual in question. As explained in more detail below, a factor in a table of the type illustrated by FIG. 19 may be used as a multiplier to adjust a baseline factor of the type found in a table illustrated by FIG. 18.

Table 1 illustrates the manner in which one embodiment of the present invention generates a mortality factor for an individual in a population. Such factors are then used, using techniques which are known in the insurance industry, to generate a quote for the particular population.

TABLE 1
MALE-AGE 34

| | Code: |
|---|---|
| Industry | 81 |
| Occupation (lawyer) | 1 |
| College Education | 3 |
| Income ($100,000) | 7 |
| Marital Status | U (Unknown) |

BASE GROUP LIFE RATES
(Baseline-0.087)

| Multiplicative Factors: | |
|---|---|
| Inc/MS/Educ/Occ | 0.400 |
| Industry | 0.956 |
| Anti-Selection | 1.000 |
| Risk Factor | 1.080 |
| FINAL | 0.036 |

The particular individual illustrated in Table 1 is a male, age 34, college educated, working as a lawyer and having an income in excess of $100,000.00. His marital status is unknown. From the portion of the table illustratively shown in FIG. 18, the baseline factor for such an individual is 0.087. From the illustrative table shown in FIG. 19, the modifying factor based upon income, marital status, education and occupation is 0.400. In the context of the table of FIG. 19, this individual is assigned an income code of 7 (from among income levels numbered 1-7), an education code of 3 (from among education levels 1-3 and unknown), a marital status of “U” or unknown (from among 3 possibilities; married, single and unknown) and an industry code of 1 (from among codes 1-12 and unknown). The resulting factor (0.400) is used as one of several multiplicative factors to modify the baseline factor initially determined from the table of FIG. 18.

Additional multiplicative factors include an industry factor (0.956), an anti-selection factor (1.000), and a risk factor (1.080). The industry factor is determined from available sources of information, such as the U.S. Department of Labor and the Society of Actuaries. This factor reflects mortality experiences of those employed in specific industries. Reliance on this factor diminishes to the extent information is available regarding other factors, such as income, marital status, occupation and education.

The anti-selection factor is indicative of whether an individual participant in the plan has a choice in electing coverage. Finally, the risk factor reflects the fact that many assumptions underlying any insurance system are based on imperfect knowledge. Risk factors usually vary in accordance with the size of the group, with groups having factors which may be as high as 25% and as low as 2%.

The factors discussed above are used as multipliers to modify the baseline rate which would otherwise be used in developing pricing for group life insurance coverage. The final rating for the individual illustrated in Table 1 (0.036) is markedly different from the baseline rate which would likely have been used in many prior art processes.

In addition to a base group life rate, the embodiment of the invention illustrated and discussed above may include a quote for accidental death and dismemberment (“AD&D”) coverage for the group. The process used to develop a factor used in deriving group AD&D rates for the 34 year old male discussed above is shown in Table 2.

TABLE 2
GROUP AD&D RATES (Baseline-0.027 = 0.318/12)

| Multiplicative Factors: | |
|---|---|
| Inc/MS/Educ/Occ | 0.400 |
| Industry | 0.956 |
| Seat Belt Rider | 1.000 |
| FINAL | 0.010 |

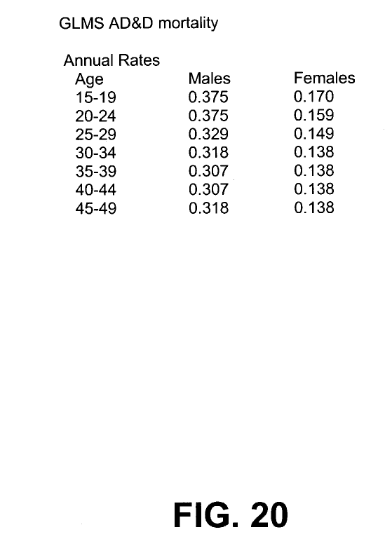

A baseline rate is derived from an analysis of statistics available for accidental death and dismemberment mortality for the subject individual. An example of a table of such factors is shown in FIG. 20. For the 34 year old male in question, the factor from the table of FIG. 20 is 0.318. These factors are based on annual rates, while the baseline figure of Table 2 (0.027) is based on one month (i.e., is equal to 0.318 divided by 12). The baseline rate is then adjusted by multiplicative factors for income/marital status/education/occupation (0.400), and industry (0.956), as described above. In this particular example, an additional factor indicating the existence of a seat belt rider is included. Other factors may be applied in particular situations. The final group AD&D rate factor attributable to this individual is obtained by multiplying 0.027 by each of the multiplicative factors to obtain the final rate of 0.010.

Rate factors for use in pricing coverage for spouses and other dependents of group members may be calculated by the system in a similar fashion. Mortality data for use in pricing such coverage is readily available. After a final rate is generated for each individual in the group, including add-on coverages, spouses and other dependents, the individual rates are weighted by volume for the multiple lives within the group to derive a final rate or rates for the group. The system and method thus allows for evaluation of multiple coverages on multiple risks.

New groups can be underwritten using the system and method of the present invention based upon the census data, information sources and known actuarial techniques. Underwriting of new groups may include use of mortality tables from one or more of the sources noted above. Actual experience with a particular group may also be considered, to the extent such experience is deemed credible. Information regarding the existence of experience in connection with particular groups is solicited by the template, as illustrated in FIG. 16.

Renewal underwriting can also be performed using the system and method of the present invention based upon updated census data, and the information sources and actuarial techniques referenced above. In the case of renewal underwriting, data from previous periods may be saved by the system and used in the course of renewal underwriting.

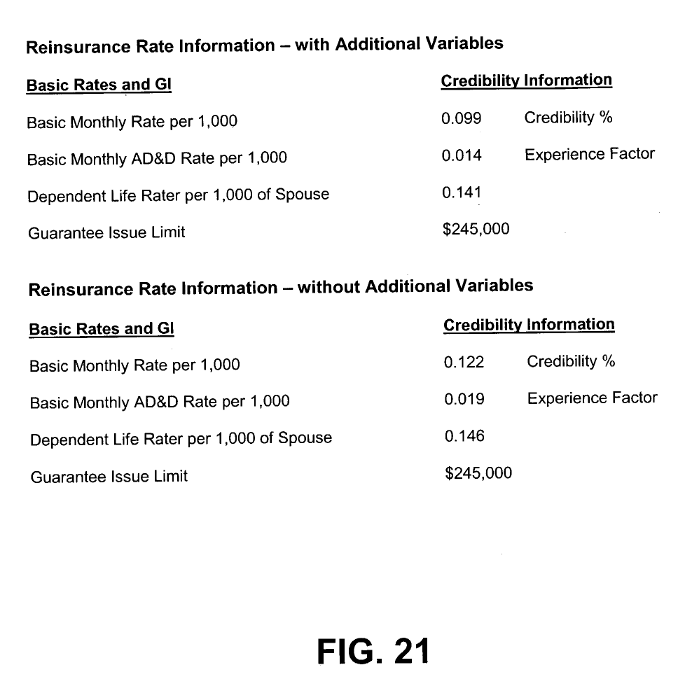

FIG. 21 shows an illustrative sample output of the system and method of FIG. 1. In FIG. 21, two “versions” of output are illustrated. The first illustrates basic rates and a guaranteed issue limit for coverage in which the variables of income, marital status, education and occupation have been considered. For purposes of illustration and comparison, a second set of rates, without considering these additional variables, is also produced. In this case, the rates produced by the system would be higher when the additional variables were not considered. The user of the system in this instance would be able to price coverage more competitively if the additional variables are taken into account.

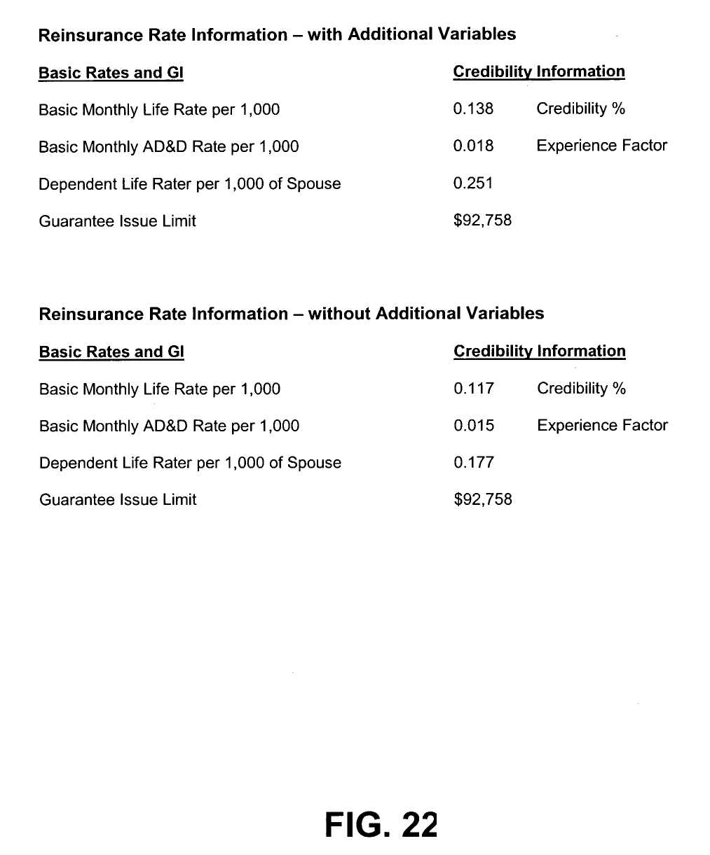

FIG. 22 shows another illustrative sample output of the system and method of the present invention. In this instance, the rates produced by the system without considering the additional variables are less than the rates produced by the system when income, marital status, education and occupation are considered. This result allows the user to price coverage at a rate which is more likely to be profitable and which more closely reflects the actual risk involved. While the higher price associated with such coverage may result in a non-competitive bid, the user will at least avoid a probable loss on the subject business.

Throughout this description and the accompanying claims, the terms “correlation” and “correlated” are used (e.g., “a plurality of factors correlated to the short term risk.”). These terms are not used in the narrow mathematical sense of a particular second order moment of a probability distribution. Rather, these terms are used in a sense intended to indicate the presence of, or a measure of, the dependence between two or more variables.

Additional information which describes features and characteristics which may be implemented in certain embodiments of the system and method of the invention are enclosed as part of this provisional application. Although the invention has been described and illustrated in detail, it is to be clearly understood that the same is intended by way of illustration and example only and is not to be taken by way of limitation.

What is claimed is:

1. A method of evaluating short term risk, comprising the steps of:
a) identifying a population of individual risks;
b) assigning a baseline factor to each of the individual risks in the population;
c) developing, by a statistical regression technique, a table of modification factors;
d) modifying the baseline factors, using one or more of the modification factors, assigned to the individual risks; and
e) generating a quote for insurance coverage for the short term risk using the modified baseline factors.

2. The method of claim 1, wherein the step of developing, by a statistical regression technique, a table of modification factors includes the step of determining the relative importance of a plurality of factors correlated to the short term risk.

3. The method of claim 1, wherein the step of developing, by a statistical regression technique, a table of modification factors includes the step of determining the relative degree of correlation of a plurality of factors correlated to the short term risk.

4. The method of claim 1, wherein the step of developing, by a statistical regression technique, a table of modification factors includes the step of selecting a plurality of factors correlated to the short term risk.

5. The method of claims 2, 3 or 4, wherein the short term risk is a group life insurance product, and wherein the plurality of factors correlated to the short term risk include two or more of the following: benefit class schedule, age, gender, amount of coverage, waiver of premium definition, dependent spouse and child coverages, cases with premium continuance for disabled lives, supplemental coverages, smoking status, relevant recent experience, industry, income, location of workplace, marital status, education, and occupation.

6. The method of claim 1, wherein the step of generating a quote comprises the step of generating a plurality of alternative quotes for review and consideration by a user.

7. The method of claim 6, further comprising the steps of generating indicia and assigning the indicia to the quotes.

8. The method of claim 1, further comprising the step of collecting data relating to the individual risks.

9. The method of claim 8, wherein the step of collecting data includes the step of populating a data template with data relating to the individual risks.

10. The method of claim 8, wherein the step of generating a quote comprises the step of calculating, using the data from the data template, an insurance rate and one or more rates for additional coverages or features.

11. The method of claim 8, wherein said short term risk is a group life insurance product and wherein said data template includes data fields for entry of data concerning individual members of a covered population.

12. The method of claim 11, wherein said data fields include data relating to one or more of the following: benefit class schedule, age, gender, amount of coverage, waiver of premium definition, dependent spouse and child coverages, cases with premium continuance for disabled lives, supplemental coverages, smoking status, relevant recent experience, industry, income, location of workplace, marital status, education, and occupation.

13. The method of claim 8, wherein said short term risk is a group life insurance product, and wherein said data template includes data fields relating to at least one of classes of coverage, a sponsoring entity providing a life insurance benefit to a covered population, and limits and features of the group life insurance product.

14. The method of claim 1, further comprising the step of reviewing the quote to determine a need for facultative review and, if needed, the steps of obtaining review by an insurer or reinsurer, entering information received as a result of the review, and regenerating the quote.

15. The method of claim 1, comprising the additional step of saving the quote in a quote file.

16. The method of claim 15, comprising the additional steps of conducting experience analysis on quotes saved in the quote file, and producing a management report.

17. The method of claim 1, further comprising the additional steps of providing a computer having a memory, and storing data relative to the individual risks, the baseline factors and the modification factors in the computer memory for use in the step of generating a quote.

18. The method of claim 1, further comprising the additional steps of providing a first computer, establishing communications between the first computer and a second computer, transferring a data template from the first computer to the second computer, and, using the second computer, populating the data template with data relating to the short term risk.

19. The method of claim 18, wherein the short term risk is a group life insurance product, and wherein the data includes one or more of the following: benefit class schedule, age, gender, amount of coverage, waiver of premium definition, dependent spouse and child coverages, cases with premium continuance for disabled lives, supplemental coverages, smoking status, relevant recent experience, industry, income, location of workplace, marital status, education, and occupation.

20. The method of claim 1, further comprising the additional steps of:
a) providing a first computer;
b) establishing communications between the first computer and a second computer;
c) providing a user of the second computer with a menu of options from which to select an operation to be performed on the first computer, said options including one or more of the following:
1. download an input template;
2. generate a quote for insurance coverage for a short term risk;
3. view past quotes generated by and stored on the first computer;
4. view sold quotes stored in the first computer; and
5. view a user agreement;
d) monitoring for a selection made by the user; and
e) implementing the selected operation.

21. The method of claim 20, wherein the short term risk is a group life insurance product for a population of individuals, and further comprising the additional steps of constructing a table of baseline factors and storing the table in the first computer.

22. The method of claim 21, wherein said table of baseline factors is broken down by gender and age.

23. The method of claim 21, comprising the additional step of storing the table of modification factors in the first computer.

24. The method of claim 23, wherein said modification factors are statistically related to at least one of income, education, occupation and marital status.

25. The method of claim 23, wherein said modification factors are statistically related to at least one or more of the following: benefit class schedule, age, gender, amount of coverage, waiver of premium definition, dependent spouse and child coverages, cases with premium continuance for disabled lives, supplemental coverages, smoking status, relevant recent experience, industry, income, location of workplace, an anti-selection factor, and a risk factor.

26. A system for evaluating short term risk, comprising:
a) a first computer;
b) means for establishing communications between the first computer and a second computer;
c) program means for providing a user of the second computer with a menu of options from which to select an operation to be performed on the first computer, said options including one or more of the following:
1. download an input template;
2. generate a quote for insurance coverage for a short term risk;
3. view past quotes generated by and stored on the first computer; and
4. view sold quotes stored in the first computer;
d) means for monitoring for a selection made by the user; and
e) means for implementing the selected operation.

27. The system according to claim 26, wherein said first computer comprises memory means for storing data relating to the short term risk.

28. The system of claim 27, wherein said data relating to the short term risk is entered in the input template by a user of the second computer system, and subsequently communicated to the first computer system for storage in the memory means.

29. The system of claim 27, further comprising a table of baseline factors relating to the short term risk stored in the memory means.

30. The system of claim 29, further comprising a table of modification factors stored in the memory means.

31. The system of claim 30, further comprising means for generating a quote for insurance coverage for the short term risk using the data, one or more of the baseline factors, and one or more of the modification factors stored in the memory means.

32. The system of claim 31, further comprising means for displaying a generated quote to a user of the second computer system.

33. The system of claim 30, wherein said modification factors are statistically related to at least one of income, education, occupation and marital status.

34. The system of claim 30, wherein the short term risk is a group life insurance product, and further comprising means for identifying a population of individuals to be covered by said product, means for assigning a baseline factor to each of the individuals in the population, and means for modifying the baseline factors, using one or more of the modification factors stored in the memory means.

35. The system of claim 29, wherein said table of baseline factors is broken down by gender and age.

36. The system of claim 34, further comprising means for generating a quote for insurance coverage for the product using the modified baseline factors.

37. The system of claim 34, further comprising means for generating and storing in the memory means a plurality of alternative quotes for review and consideration by a user.

38. The system of claim 37, further comprising means for generating indicia and assigning the indicia to the plurality of alternative quotes.

39. The system of claim 27, wherein the short term risk is a group life insurance product, and wherein said data relating to the short term risk includes one or more of the following: benefit class schedule, age, gender, amount of coverage, waiver of premium definition, dependent spouse and child coverages, cases with premium continuance for disabled lives, supplemental coverages, smoking status, relevant recent experience, industry, income, location of workplace, marital status, education, and occupation.
